(19) United States
(12) Patent Application Publication
(10) Pub. No.: US 2025/0377483 A1
(43) Pub. Date: Dec. 11, 2025

(54) GLOBAL SOLAR RADIATION AMOUNT ESTIMATION DEVICE, GLOBAL SOLAR RADIATION AMOUNT LEARNING DEVICE, GLOBAL SOLAR RADIATION AMOUNT ESTIMATION METHOD, AND GLOBAL SOLAR RADIATION AMOUNT ESTIMATION PROGRAM

(71) Applicant: NTT, Inc., Tokyo (JP)

(72) Inventors: Toshitaka MAKI, Tokyo (JP); Natsuko HIKAGE, Tokyo (JP); Takashi FUJINAMI, Tokyo (JP)

(73) Assignee: NTT, Inc., Tokyo (JP)

(21) Appl. No.: 18/876,663

(22) PCT Filed: Aug. 8, 2022
(86) PCT No.: PCT/JP2022/030342

§ 371 Date: Dec. 19, 2024

(30) Foreign Application Priority Data
Jun. 22, 2022 (WO) PCT/JP2022/024961

(51) Int. Cl. G01W 1/10; H02S 40/30

(52) U.S. Cl. CPC G01W 1/10; H02S 40/30

(57) ABSTRACT

A global solar radiation amount estimation device includes: a feature amount acquisition unit that acquires power generation actual data including a power generation amount at a power generation point; and an estimation unit that estimates a global solar radiation amount corresponding to the power generation actual data acquired by the feature amount acquisition unit using a learned model that is generated by machine learning, as learning data, a set of the power generation actual data prepared in advance and a corresponding global solar radiation amount of ground observation, receives the power generation actual data as an input, and outputs the global solar radiation amount.

### TECHNICAL FIELD

The disclosed technology relates to a global solar radiation amount estimation device, a global solar radiation amount learning device, a global solar radiation amount estimation method, and a global solar radiation amount estimation program.

### BACKGROUND ART

The amount of power generated by solar power generation depends on weather conditions. On the other hand, a company that supplies power performs power transaction based on a power generation amount planned in advance, and even if the power generation result is larger or smaller than the plan, it causes a decrease in revenue and an increase in cost.

For planning, it is most important to accurately predict the global solar radiation amount at the power generation point, but there are few points (weather stations) where the global solar radiation amount is observed by dedicated devices. For this reason, weather companies, electric companies, and the like are working on prediction from a small amount of information. There is a technology of estimating a global solar radiation amount that greatly affects the amount of solar power generation (see, for example, Non Patent Literature 1).

### CITATION LIST

### Non Patent Literature

Non Patent Literature 1: Atsushi Hashimoto and Akira Usami, “Development of a satellite-based real-time solar irradiance estimation and forecasting system using Himawari-8” Report by Central Research Institute of Electric Power Industry, N16001, January 2017 (https://criepi.denken.or.jp/hokokusho/pb/reportDownload?reportNoUkCode=N16001&tenpu TypeCode=30&seqNo=1&reportId=8723).

### SUMMARY OF INVENTION

### Technical Problem

However, in a method using a meteorological satellite image in which clouds are photographed as in the technology described in Non Patent Literature 1, observation accuracy of the global solar radiation amount is not high. In addition, the influence of the terrain such as the altitude of the mesh (range obtained by dividing area into 1 km square, 10 km square, and the like) of the global solar radiation amount estimation target and the shadow of the mountain is not taken into consideration.

FIG. 27 is a diagram schematically illustrating a relationship between a cloud and a solar radiation amount. In order to accurately estimate the global solar radiation amount, it is better to consider the influence of the cloud, but in the conventional method using the meteorological satellite image, the influence of the cloud is not sufficiently considered. FIG. 28 is a diagram schematically illustrating a relationship between the terrain and the solar radiation amount. In order to accurately estimate the global solar radiation amount, it is better to consider the influence of the terrain, but in the conventional method using the meteorological satellite image, the influence of the terrain is not sufficiently considered. For these reasons, the estimation accuracy of the global solar radiation amount has not been improved.

The disclosed technology has been made in view of the above points, and an object thereof is to provide a global solar radiation amount estimation device, a global solar radiation amount learning device, a global solar radiation amount estimation method, and a global solar radiation amount estimation program capable of accurately estimating a global solar radiation amount.

### Solution to Problem

A first aspect of the present disclosure is a global solar radiation amount estimation device including: a feature amount acquisition unit that acquires power generation actual data including a power generation amount at a power generation point; and an estimation unit that estimates a global solar radiation amount corresponding to the power generation actual data acquired by the feature amount acquisition unit using a learned model that is generated by machine learning, as learning data, a set of the power generation actual data prepared in advance and a corresponding global solar radiation amount of ground observation, receives the power generation actual data as an input, and outputs the global solar radiation amount.

A second aspect of the present disclosure is a global solar radiation amount learning device including: a learning data acquisition unit that acquires learning data that is a set of power generation actual data including a power generation amount at a power generation point and a global solar radiation amount of corresponding ground observation; and a learning unit that generates a learned model that receives the power generation actual data as an input and outputs the global solar radiation amount by performing machine learning using the learning data acquired by the learning data acquisition unit.

A third aspect of the present disclosure is a global solar radiation amount estimation method including: acquiring power generation actual data including a power generation amount at a power generation point; and estimating a global solar radiation amount corresponding to the power generation actual data acquired, using a learned model that is generated by machine learning, as learning data, a set of the power generation actual data prepared in advance and a corresponding global solar radiation amount of ground observation, receives the power generation actual data as an input, and outputs the global solar radiation amount.

A fourth aspect of the present disclosure is a global solar radiation amount estimation program that causes a computer to execute: acquiring power generation actual data including a power generation amount at a power generation point; and estimating a global solar radiation amount corresponding to the power generation actual data acquired, using a learned model that is generated by machine learning, as learning data, a set of the power generation actual data prepared in advance and a corresponding global solar radiation amount of ground observation, receives the power generation actual data as an input, and outputs the global solar radiation amount.

### Advantageous Effects of Invention

According to the disclosed technology, it is possible to accurately estimate a global solar radiation amount.

### BRIEF DESCRIPTION OF DRAWINGS

FIG. 1 is a diagram illustrating an example of input data and output data used for global solar radiation amount estimation processing according to a first embodiment.

FIG. 2 is a block diagram illustrating an example of a hardware configuration of the global solar radiation amount estimation device according to the first embodiment.

FIG. 3 is a block diagram illustrating an example of a functional configuration of the global solar radiation amount estimation device according to the first embodiment.

FIG. 4 is a flowchart illustrating an example of a flow of processing by a global solar radiation amount estimation program according to the first embodiment.

FIG. 5 is a block diagram illustrating an example of a hardware configuration of the global solar radiation amount learning device according to the first embodiment.

FIG. 6 is a block diagram illustrating an example of a functional configuration of the global solar radiation amount learning device according to the first embodiment.

FIG. 7 is a flowchart illustrating an example of a flow of processing by the global solar radiation amount learning program according to the first embodiment.

FIG. 8 is a block diagram illustrating an example of a functional configuration of a global solar radiation amount estimation device according to a second embodiment.

FIG. 9 is a flowchart illustrating an example of a flow of processing by a global solar radiation amount estimation program according to the second embodiment.

FIG. 10 is a graph illustrating a comparative example of a global solar radiation amount on a fine day.

FIG. 11 is a graph illustrating a comparative example of a global solar radiation amount on a cloudy day.

FIG. 12 is a graph illustrating a comparative example of a global solar radiation amount on a cloudy day.

FIG. 13 is a graph illustrating a comparative example with observation values at a meteorological observatory.

FIG. 14 is a diagram illustrating a comparative example of a global solar radiation amount estimated using power generation actual data and a global solar radiation amount estimated using a meteorological satellite image.

FIG. 15 is a diagram illustrating a comparative example of a global solar radiation amount estimated using power generation actual data and a global solar radiation amount estimated using a meteorological satellite image.

FIG. 16 is a block diagram illustrating an example of a functional configuration of a global solar radiation amount estimation device according to a third embodiment.

FIG. 17 is a flowchart illustrating an example of a flow of processing by a global solar radiation amount estimation program according to the third embodiment.

FIG. 18 is a block diagram illustrating an example of a functional configuration of a global solar radiation amount learning device according to the third embodiment.

FIG. 19 is a flowchart illustrating an example of a flow of processing by a global solar radiation amount learning program according to the third embodiment.

FIG. 20 is a diagram illustrating a comparison example between a corrected forecast value of a global solar radiation amount according to the present technology and a forecast value of a global solar radiation amount according to a conventional technology.

FIG. 21 is a scatter diagram illustrating a comparative example of correction performance of a forecast according to the present technology and performance of a forecast according to the conventional technology.

FIG. 22 is a diagram illustrating a comparison example between a corrected forecast value of a global solar radiation amount according to the present technology and a forecast value of a global solar radiation amount according to a conventional technology.

FIG. 23 is a diagram illustrating a comparison example between a corrected forecast value of a global solar radiation amount according to the present technology and a forecast value of a global solar radiation amount according to a conventional technology.

FIG. 24 is a graph illustrating a comparative example of a global solar radiation amount on a fine day.

FIG. 25 is a graph illustrating a comparative example of a global solar radiation amount on a cloudy day.

FIG. 26 is a graph illustrating a comparative example of a global solar radiation amount on a cloudy day.

FIG. 27 is a diagram schematically illustrating a relationship between a cloud and a solar radiation amount.

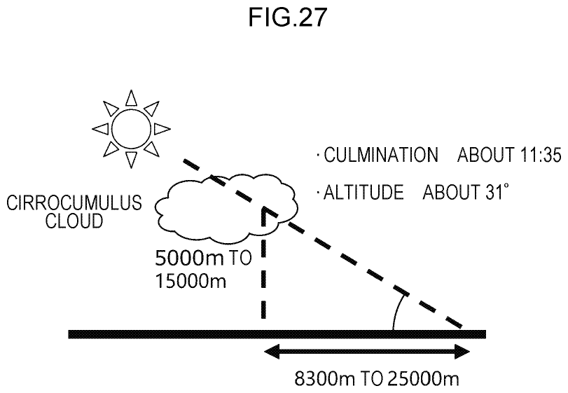

FIG. 28 is a diagram schematically illustrating a relationship between a terrain and a solar radiation amount.

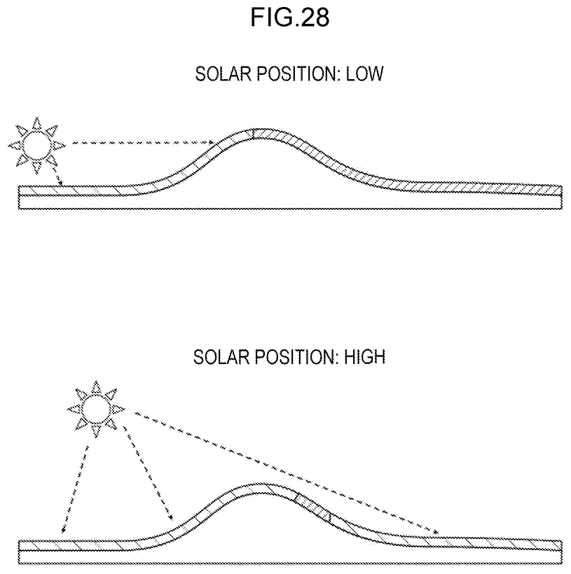

### DESCRIPTION OF EMBODIMENTS

The following is a description of an example of embodiments of the technology disclosed herein, with reference to the drawings. In the drawings, the same or equivalent components and portions will be denoted by the same reference signs. Moreover, dimensional ratios in the drawings are exaggerated for convenience of description and thus may be different from actual ratios.

A global solar radiation amount estimation device and a global solar radiation amount learning device according to the present embodiment provide specific improvement over a conventional method of estimating a global solar radiation amount using a meteorological satellite image, and show improvement in a technical field of estimating a global solar radiation amount.

In the present embodiment, power generation actual data is used as an input value of machine learning. This power generation actual data can be obtained from a power generation point where a solar panel is installed, and can be easily obtained by a power generation company. Since the power generation actual data reflects the influence of clouds, terrain, and the like, the estimation accuracy of the global solar radiation amount becomes higher as compared with the case of using the meteorological satellite image, and the power generation company or the like can prepare a highly accurate power generation plan on the basis of the global solar radiation amount. Here, the global solar radiation amount is the sum of light energy from all directions of the sky, and is obtained by the following Expression (1).

Global solar radiation amount=direct solar radiation amount+scattered solar radiation amount (1)

### First Embodiment

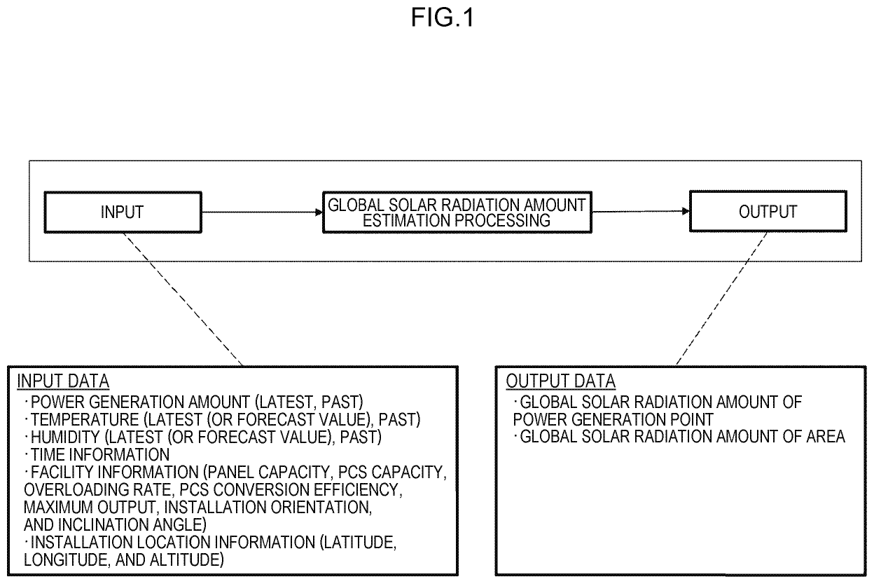

FIG. 1 is a diagram illustrating an example of input data and output data used for global solar radiation amount estimation processing according to a first embodiment.

As illustrated in FIG. 1, the input data is data input to a learned model used for the global solar radiation amount estimation processing, and is an example of power generation actual data. The input data includes, for example, a power generation amount, temperature information, humidity information, time information, equipment information, and installation location information at the power generation point. The power generation point is a point where a solar panel is installed. The power generation amount includes latest data and past data. The temperature information includes latest data (or forecast value) and past data. The humidity information includes latest data (or forecast value) and past data. The equipment information includes, for example, a panel capacity, a power conditioning system (PCS) capacity, an overloading rate, a PCS conversion efficiency, a maximum output, an installation orientation, an inclination angle, a temperature coefficient, and the like. The installation location information includes the latitude, longitude, altitude, and the like of the installation location.

The panel capacity indicates the total capacity of a solar panel in a power generation facility, and the panel capacity is expressed by the number of panels installed×the panel installation capacity. The PCS has a DC-AC conversion (inverter) function. The PCS capacity is expressed by the number of PCS installations×the PCS installation capacity. The overloading rate is expressed by panel capacity/PCS capacity. The higher the overloading rate, the more stable the power generation output, but the higher the installation cost. The PCS conversion efficiency indicates the conversion efficiency of DC-AC conversion, and the conversion efficiency is often 98%. The maximum output indicates the past maximum output calculated from the power generation actual result. The installation orientation indicates the orientation in which the solar panel is installed, and the power generation output is maximized by installing the solar panel in the south direction (180 degrees). Installation conditions (orientation of the plane of the roof, or the like) are different for each facility. The inclination angle indicates an angle at which the solar panel is installed, and the solar panel is installed at, for example, 30 degrees, thereby maximizing the power generation output throughout the year. Installation conditions (inclination of the roof, or the like) are different for each facility. The temperature coefficient generally maximizes the power generation efficiency when the temperature of the solar panel is 25° C. The power generation efficiency decreases at a temperature coefficient of 0.5%/° C. based on 25° C.

On the other hand, the output data is data output from the learned model in the global solar radiation amount estimation processing. The output data includes, for example, the global solar radiation amount at the power generation point and the global solar radiation amount in the area.

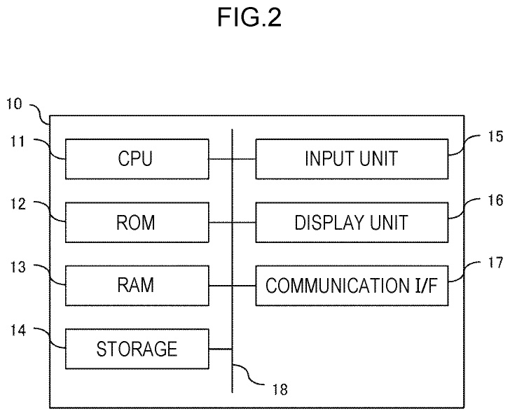

Next, a hardware configuration of the global solar radiation amount estimation device 10 according to the first embodiment will be described with reference to FIG. 2.

FIG. 2 is a block diagram illustrating an example of a hardware configuration of the global solar radiation amount estimation device 10 according to the first embodiment.

As illustrated in FIG. 2, the global solar radiation amount estimation device 10 includes a central processing unit (CPU) 11, a read only memory (ROM) 12, a random access memory (RAM) 13, a storage 14, an input unit 15, a display unit 16, and a communication interface (I/F) 17. The respective components are connected to each other via a bus 18 such that they can communicate.

The CPU 11 is a central processing unit, which executes various programs and controls each unit. That is, the CPU 11 reads a program from the ROM 12 or the storage 14, and executes the program using the RAM 13 as a working area. The CPU 11 controls the above-described each component and performs various types of operation processing according to the program stored in the ROM 12 or the storage 14. In the present embodiment, a global solar radiation amount estimation program used to execute global solar radiation amount estimation processing is stored in the ROM 12 or the storage 14. Note that, for example, a graphics processing unit (GPU) may be used, instead of the CPU.

The ROM 12 stores various programs and various types of data. The RAM 13, as a working area, temporarily stores programs or data. The storage 14 includes a hard disk drive (HDD) or a solid state drive (SSD) and stores various programs including an operating system and various types of data.

The input unit 15 includes a pointing device such as a mouse and a keyboard and is used to perform various inputs to the allocation search device.

The display unit 16 is, for example, a liquid crystal display and displays various types of information. The display unit 16 may function as the input unit 15 by adopting a touch panel system.

The communication interface 17 is an interface through which the allocation search device communicates with another external device. The communication is performed in conformity to, for example, a wired communication standard such as Ethernet (registered trademark) or fiber distributed data interface (FDDI) or a wireless communication standard such as 4G, 5G, or Wi-Fi (registered trademark).

For example, a general-purpose computer device such as a server computer or a personal computer (PC) is applied to the global solar radiation amount estimation device 10 according to the present embodiment.

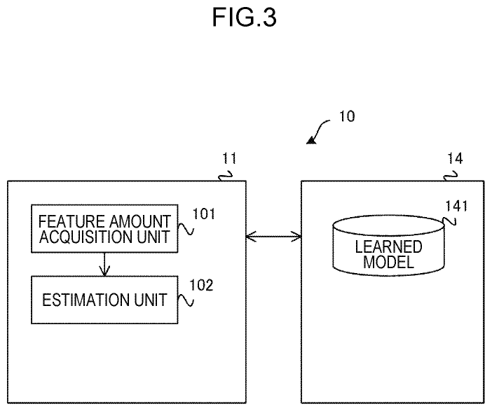

Next, a functional configuration of the global solar radiation amount estimation device 10 will be described with reference to FIG. 3.

FIG. 3 is a block diagram illustrating an example of a functional configuration of the global solar radiation amount estimation device 10 according to the first embodiment.

As illustrated in FIG. 3, the global solar radiation amount estimation device 10 includes a feature amount acquisition unit 101 and an estimation unit 102 as functional configurations. Each functional configuration is achieved by the CPU 11 reading the global solar radiation amount estimation program stored in the ROM 12 or the storage 14, and loading and executing the global solar radiation amount estimation program in the RAM 13.

The storage 14 stores a learned model 141. The learned model 141 is generated by machine learning, as learning data, a set of power generation actual data prepared in advance and a corresponding global solar radiation amount of ground observation. The learned model 141 is a model that is generated by a global solar radiation amount learning device 20 to be described later, receives the power generation actual data as an input, and outputs the global solar radiation amount.

The feature amount acquisition unit 101 acquires power generation actual data including a power generation amount at a power generation point. As described above, the power generation actual data may include at least one of temperature information, humidity information, time information, equipment information, and installation location information at the power generation point.

The estimation unit 102 estimates the global solar radiation amount corresponding to the power generation actual data acquired by the feature amount acquisition unit 101 using the learned model 141. The estimation unit 102 may estimate the global solar radiation amount at each power generation point included in a predetermined area (=mesh). The estimation result for each power generation point obtained by the estimation by the estimation unit 102 is stored in, for example, the storage 14.

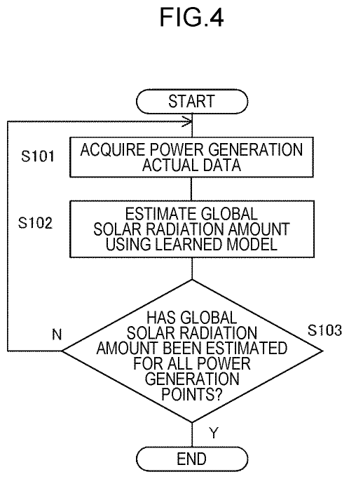

Next, an action of the global solar radiation amount estimation device 10 according to the first embodiment will be described with reference to FIG. 4.

FIG. 4 is a flowchart illustrating an example of a flow of processing by the global solar radiation amount estimation program according to the first embodiment. The processing by the global solar radiation amount estimation program is implemented by writing the global solar radiation amount estimation program stored in the ROM 12 or the storage 14 into the RAM 13 by the CPU 11 of the global solar radiation amount estimation device 10 and executing the global solar radiation amount estimation program.

In step S101 of FIG. 4, the CPU 11 acquires the power generation actual data at the power generation point where the solar panel is installed. As an example, the power generation actual data is represented as the input data illustrated in FIG. 1 described above.

In step S102, the CPU 11 receives the power generation actual data acquired in step S101 as an input, and estimates the corresponding global solar radiation amount using the learned model 141.

In step S103, the CPU 11 determines whether the global solar radiation amount has been estimated for all the power generation points in the predetermined area. When it is determined that the global solar radiation amount has not been estimated for all the power generation points (in the case of negative determination), the process proceeds to step S101, and when it is determined that the global solar radiation amount has been estimated for all the power generation points (in the case of positive determination), a series of processes by the global solar radiation amount estimation program ends.

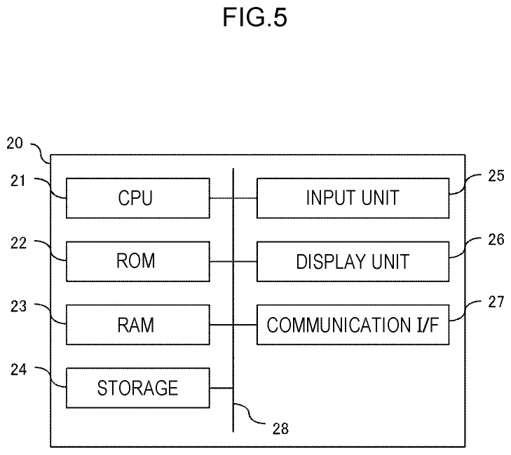

Next, a hardware configuration of the global solar radiation amount learning device 20 according to the first embodiment will be described with reference to FIG. 5.

FIG. 5 is a block diagram illustrating an example of a hardware configuration of the global solar radiation amount learning device 20 according to the first embodiment.

As illustrated in FIG. 5, the global solar radiation amount learning device 20 includes a CPU 21, a ROM 22, a RAM 23, a storage 24, an input unit 25, a display unit 26, and a communication interface (I/F) 27. The components are communicably connected to each other via a bus 28.

The CPU 21 is a central processing unit, executes various programs, and controls each unit. That is, the CPU 21 reads a program from the ROM 22 or the storage 24, and executes the program using the RAM 23 as a working area. The CPU 21 performs control of each of the components described above and executes various types of calculation processing according to a program stored in the ROM 22 or the storage 24. In the present embodiment, a global solar radiation amount learning program used to execute global solar radiation amount learning processing is stored in the ROM 22 or the storage 24. Note that, for example, a GPU may be used, instead of the CPU.

The ROM 22 stores various programs and various types of data. The RAM 23 as a working area temporarily stores programs or data. The storage 24 includes an HDD or an SSD, and stores various programs including an operating system and various types of data.

The input unit 25 includes a pointing device such as a mouse and a keyboard and is used to perform various inputs to the global solar radiation amount learning device 20.

The display unit 26 is, for example, a liquid crystal display, and displays various types of information. The display unit 26 may function as the input unit 25 by adopting a touch panel system.

The communication interface 27 is an interface through which the global solar radiation amount learning device 20 communicates with another external device. For the communication, for example, a wired communication standard such as Ethernet (registered trademark) or FDDI or a wireless communication standard such as 4G, 5G, or Wi-Fi (registered trademark) is used.

For example, a general-purpose computer device such as a server computer or a personal computer (PC) is applied to the global solar radiation amount learning device 20 according to the present embodiment. The global solar radiation amount learning device 20 may be configured integrally with the above-described global solar radiation amount estimation device 10.

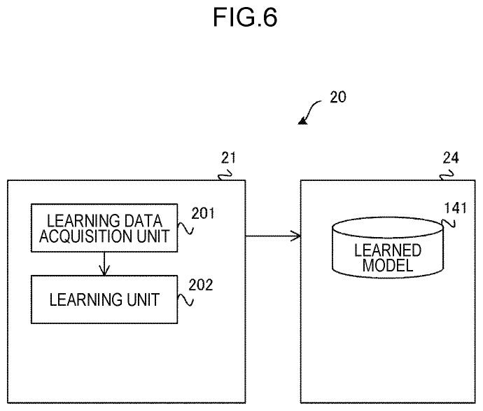

Next, a functional configuration of the global solar radiation amount learning device 20 will be described with reference to FIG. 6.

FIG. 6 is a block diagram illustrating an example of a functional configuration of the global solar radiation amount learning device 20 according to the first embodiment.

As illustrated in FIG. 6, the global solar radiation amount learning device 20 includes a learning data acquisition unit 201 and a learning unit 202 as functional configurations. Each functional configuration is achieved by the CPU 21 reading the global solar radiation amount learning program stored in the ROM 22 or the storage 24, and loading and executing the global solar radiation amount learning program in the RAM 23.

The learning data acquisition unit 201 acquires learning data that is a set of the power generation actual data including the power generation amount at the power generation point and the corresponding global solar radiation amount of the ground observation. The power generation actual data used for learning is data including a power generation amount, a maximum output of a facility, time information, and the like, similarly to the power generation actual data used for the estimation described above. The power generation actual data is, for example, data measured at a power generation point in a mesh including a weather station or the like that measures a global solar radiation amount. A group of pieces of learning data, which is a set of the power generation actual data and the past global solar radiation amount observed at the meteorological observatory or the like in the mesh, is created.

The learning unit 202 performs machine learning using the learning data acquired by the learning data acquisition unit 201 to generate the learned model 141 that receives the power generation actual data as an input and outputs the global solar radiation amount. Here, a general hyperparameter search algorithm is used as the learning model used for machine learning, and for example, a neural network or the like is applied. The learned model 141 generated by the learning unit 202 is stored in the storage 24 and also stored in the storage 14 of the global solar radiation amount estimation device 10.

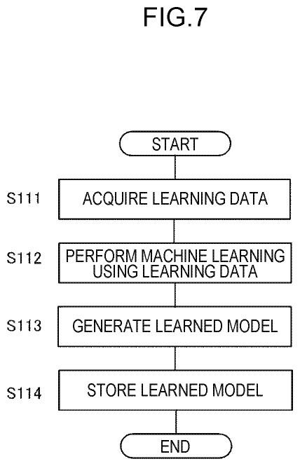

Next, an action of the global solar radiation amount learning device 20 according to the first embodiment will be described with reference to FIG. 7.

FIG. 7 is a flowchart illustrating an example of a flow of processing by the global solar radiation amount learning program according to the first embodiment. The processing by the global solar radiation amount learning program is implemented by writing the global solar radiation amount learning program stored in the ROM 22 or the storage 24 into the RAM 23 by the CPU 21 of the global solar radiation amount learning device 20 and executing the global solar radiation amount learning program.

In step S111 of FIG. 7, the CPU 21 acquires learning data that is a set of the power generation actual data including the power generation amount at the power generation point and the corresponding global solar radiation amount of the ground observation.

In step S112, the CPU 21 performs machine learning by a general hyperparameter search algorithm using the learning data acquired in step S111.

In step S113, the CPU 21 performs machine learning in step S112 to generate the learned model 141 that receives the power generation actual data as an input and outputs the corresponding global solar radiation amount.

In step S114, the CPU 21 stores the learned model 141 generated in step S113 in, for example, the storage 14 of the global solar radiation amount estimation device 10, and ends a series of processes by the global solar radiation amount learning program.

As described above, according to the present embodiment, in addition to the information of the solar power generation facility, the power generation actual data of each power generation point in which the influence of clouds, terrain, and the like is already reflected and which can be easily obtained by the power generation business company is used as the input value of the machine learning. As a result, the global solar radiation amount at the power generation point can be accurately estimated.

### Second Embodiment

In a second embodiment, a mode will be described in which a representative value of the global solar radiation amount of the mesh including the power generation point is calculated from the estimation result of the global solar radiation amount of each power generation point output in the first embodiment.

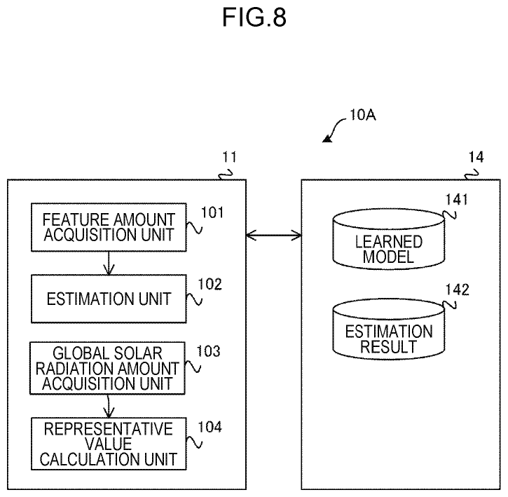

FIG. 8 is a block diagram illustrating an example of a functional configuration of a global solar radiation amount estimation device 10A according to the second embodiment.

As illustrated in FIG. 8, the CPU 11 of the global solar radiation amount estimation device 10A according to the present embodiment functions as a feature amount acquisition unit 101, an estimation unit 102, a global solar radiation amount acquisition unit 103, and a representative value calculation unit 104. The same components as those of the global solar radiation amount estimation device 10 described in the first embodiment are denoted by the same reference numerals, and repeated description thereof will be omitted.

The estimation result 142 is stored in the storage 14. The estimation result 142 is an estimation result of the global solar radiation amount at all the power generation points existing in the predetermined mesh obtained by the estimation by the estimation unit 102.

The global solar radiation amount acquisition unit 103 acquires the estimation result 142 from the storage 14.

The representative value calculation unit 104 calculates a representative value of the global solar radiation amount of the mesh from the estimation result 142 of the global solar radiation amount acquired by the global solar radiation amount acquisition unit 103. The representative value of the global solar radiation amount of the mesh is expressed as, for example, a median value of the global solar radiation amounts at all power generation points existing in the mesh. The representative value is not limited to the median value, and for example, a weighted average may be used. For example, in the case of the weighted average in consideration of the maximum output of the facility, the global solar radiation amount estimated at the large-scale power generation point more strongly affects the value of the weighted average, so that the global solar radiation amount prediction suitable for the power generation amount plan in the mesh can be obtained. In the weighted average in consideration of the maximum output of the facility, for example, in a case where there are three power generation points A, B, and C in the mesh, the maximum outputs of the facilities at each point are X_{A}, X_{B}, and X_{C}, and the global solar radiation amount estimation values are Y_{A}, Y_{B}, and Y_{C}, a value calculated by the following expression is set as a representative value of the global solar radiation amount of the mesh.

$$Representative value = ( {X}_{A} \times {Y}_{A} + {X}_{B} \times {Y}_{B} + {X}_{C} \times {Y}_{C} ) / ( {X}_{A} + {X}_{B} + {X}_{C} )$$

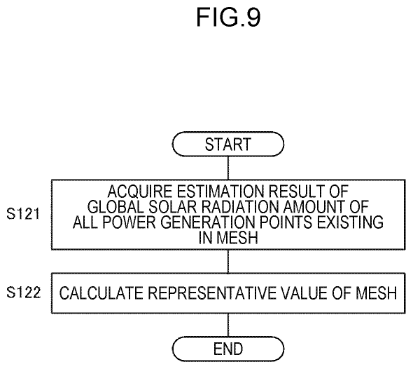

Next, an action of the global solar radiation amount estimation device 10A according to the second embodiment will be described with reference to FIG. 9.

FIG. 9 is a flowchart illustrating an example of a flow of processing by the global solar radiation amount estimation program according to the second embodiment. The processing by the global solar radiation amount estimation program is implemented by writing the global solar radiation amount estimation program stored in the ROM 12 or the storage 14 into the RAM 13 by the CPU 11 of the global solar radiation amount estimation device 10A and executing the global solar radiation amount estimation program.

In step S121 of FIG. 9, the CPU 11 acquires the estimation result 142 of the global solar radiation amounts of all the power generation points existing in the mesh from the storage 14.

In step S122, the CPU 11 calculates a representative value (for example, median value, weighted average, and the like) of the global solar radiation amount of the mesh from the estimation result 142 of the global solar radiation amount acquired in step S121, and ends a series of processes by the global solar radiation amount estimation program. As described above, the representative value of the global solar radiation amount of the mesh is expressed as, for example, a median value of the global solar radiation amounts at all power generation points existing in the mesh.

According to the present embodiment, the representative value of the global solar radiation amount of the mesh is calculated by integrating the information of the power generation points included in the mesh. As a result, the global solar radiation amount at the mesh can be more accurately estimated.

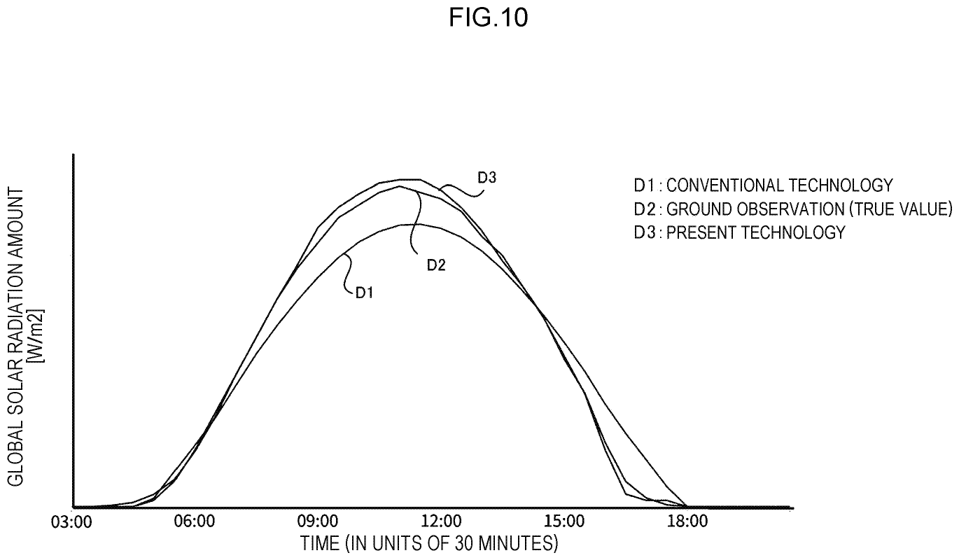

Next, an example of an experimental result according to the present embodiment will be described with reference to FIGS. 10 to 15.

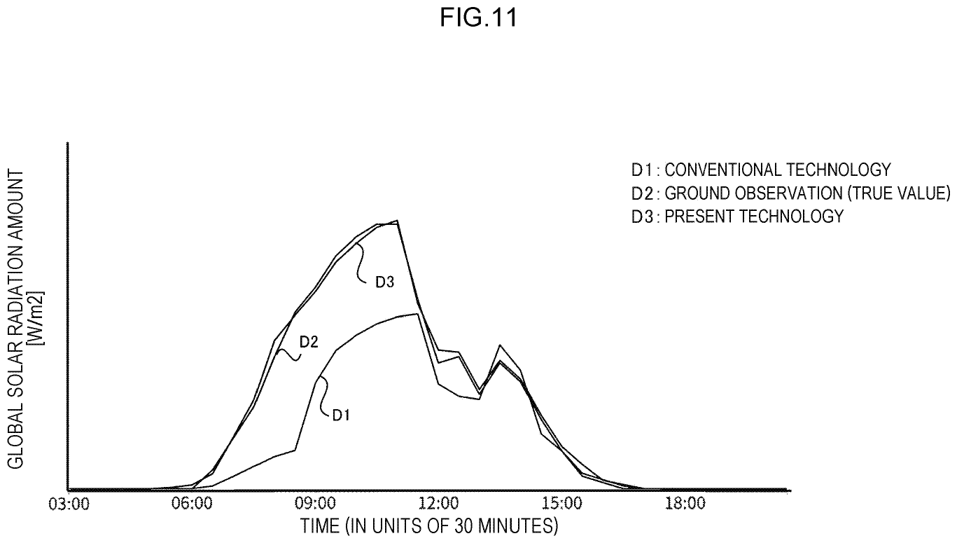

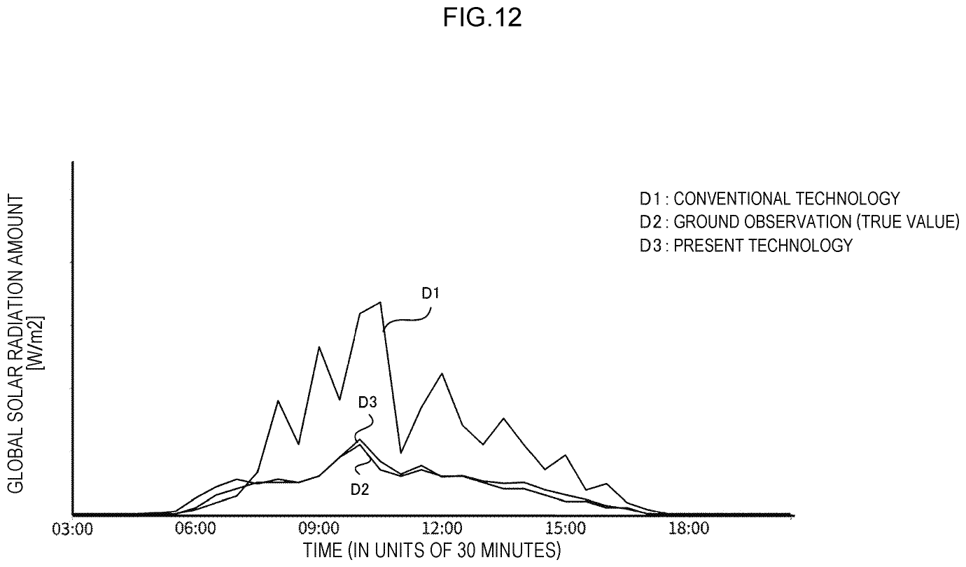

FIG. 10 is a graph illustrating a comparative example of a global solar radiation amount on a fine day. FIG. 11 is a graph illustrating a comparative example of a global solar radiation amount on a cloudy day. FIG. 12 is a graph illustrating a comparative example of a global solar radiation amount on a cloudy day. In FIGS. 10 to 12, the vertical axis represents the global solar radiation amount (unit: W/m²), and the horizontal axis represents the time zone. D1 represents a global solar radiation amount estimated using a meteorological satellite image (conventional method), D2 represents a global solar radiation amount of ground observation (correct data: true value), and D3 represents a global solar radiation amount estimated using power generation actual data (method of the present technology). However, the examples of FIGS. 10 to 12 illustrate data observed in a certain photovoltaic power generation facility.

As illustrated in FIGS. 10 to 12, it can be seen that the global solar radiation amount D3 estimated using the power generation actual data is closer to the global solar radiation amount D2 which is correct data than the global solar radiation amount D1 estimated using the meteorological satellite image regardless of the weather. That is, it can be seen that the global solar radiation amount D3 estimated using the power generation actual data has higher accuracy than the global solar radiation amount D1 estimated using the meteorological satellite image.

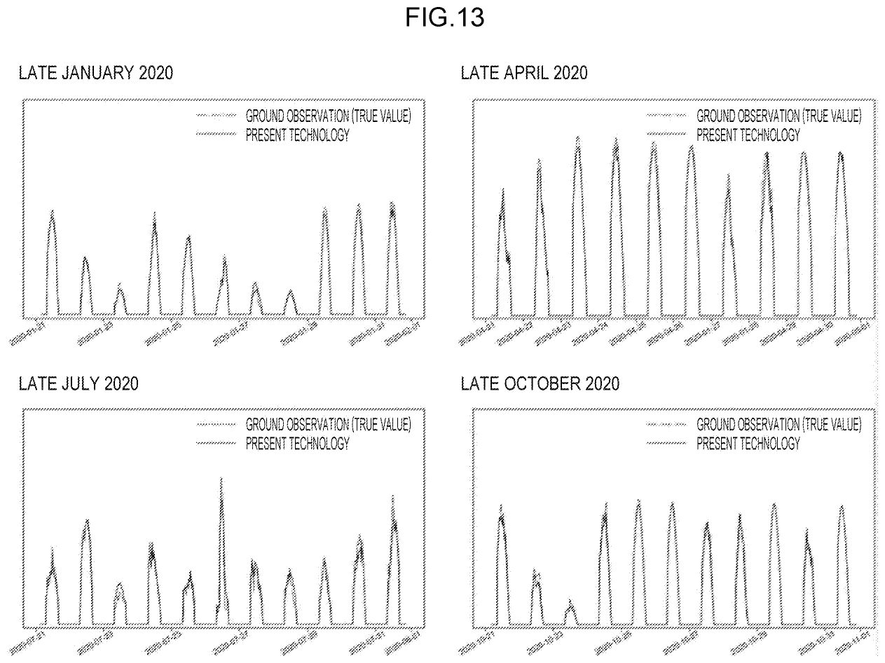

FIG. 13 is a graph illustrating a comparative example with observation values at a meteorological observatory. FIG. 13 illustrates data in late January 2020, data in late April 2020, data in late July 2020, and data in late October 2020. In FIG. 13, an alternate long and short dash line indicates a true value of the global solar radiation amount observed by the meteorological observatory, and a solid line indicates the global solar radiation amount estimated using the power generation actual data (the method of the present technology). It can also be seen from the example of FIG. 13 that the global solar radiation amount estimated using the power generation actual data is close to the true value of the global solar radiation amount that is the correct answer data.

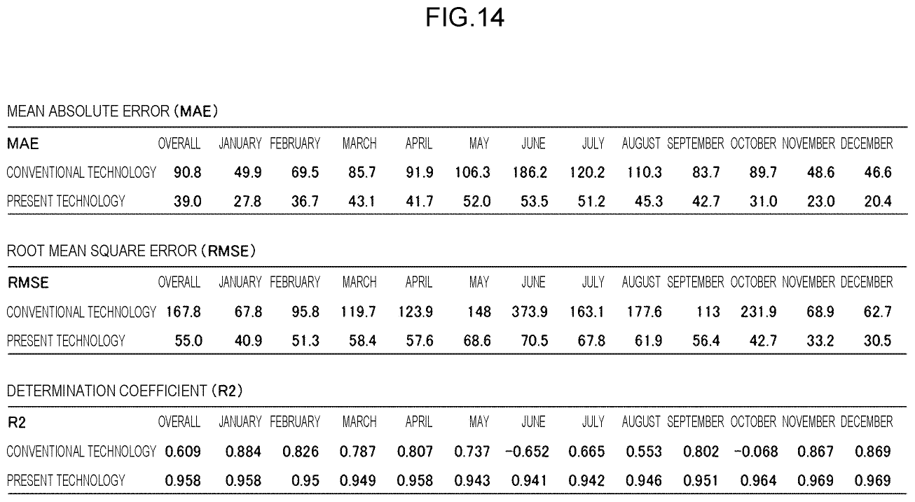

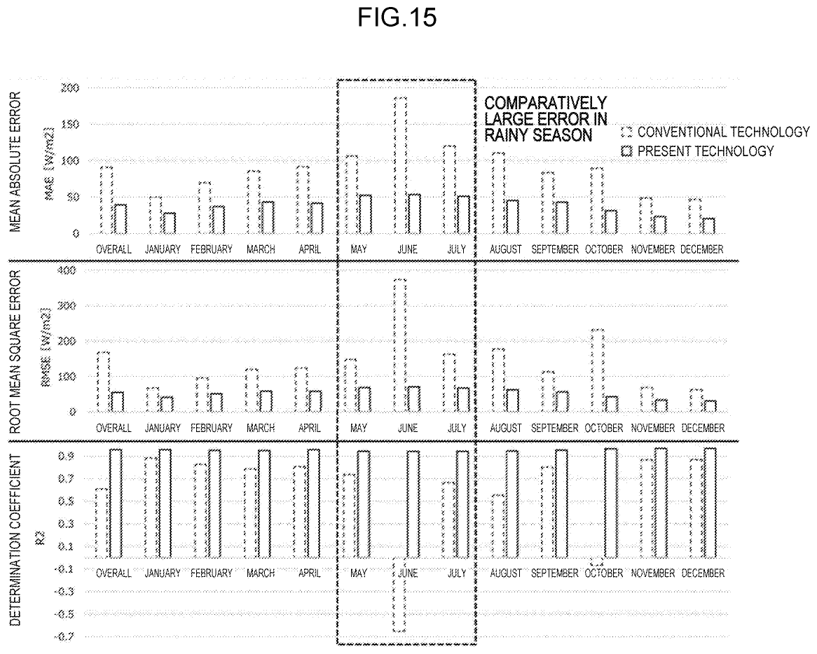

FIGS. 14 and 15 are diagrams illustrating a comparative example of a global solar radiation amount estimated using power generation actual data and a global solar radiation amount estimated using a meteorological satellite image. The graph of FIG. 15 is a graph of the numerical values of FIG. 14.

In FIGS. 14 and 15, the evaluation area is a mesh of 5 km where the observatory of the Tokyo District Meteorological Observatory is present. The evaluation period was set to the end of each month for 3 years of 2018, 2019, and 2020. As the evaluation index, a mean absolute error (MAE), a root mean square error (RMSE), and a determination coefficient (R2) were used. The dotted line in FIG. 15 indicates an index value between the global solar radiation amount estimated using the meteorological satellite image (conventional method) and the true value of the global solar radiation amount that is the correct answer data, and the solid line in FIG. 15 indicates an index value between the global solar radiation amount estimated using the power generation actual data (the method of the present technology) and the true value of the global solar radiation amount that is the correct answer data.

In any of the above evaluation indexes, it can be seen that the global solar radiation amount estimated using the power generation actual data (the method of the present technology) has higher accuracy than the global solar radiation amount estimated using the meteorological satellite image (the conventional method).

Here, as described above, there is a strong correlation between the power generation output (power generation actual data) of the solar panel and the global solar radiation amount, but there are various factors that affect the magnitude of the power generation output. Specifically, the power generation facility includes, for example, a panel capacity, a PCS capacity, an overloading rate, a PCS conversion efficiency, a maximum output, an installation orientation, an inclination angle, a temperature coefficient, and the like. The weather conditions include, for example, a global solar radiation amount, a sunshine time, a temperature, and the like. The sunshine time is a time when the direct solar radiation amount is 120 W/m² or more. The temperature of the solar panel is indirectly considered as the air temperature. The other conditions include, for example, altitude, latitude/longitude, week number, and the like. The higher the altitude, the longer the sunshine time and the less likely it is to be covered by the shadow of the mountain. In addition, the week number represents a number of a serial number of the year when Monday at the beginning of the year is defined as 0 week, and the angle of the sun in the south is indirectly considered.

Since the power generation output is different even in a facility having the same panel capacity or PCS capacity, it is desirable to consider the above-described various elements.

### Third Embodiment

In a third embodiment, a mode will be described in which feature amount data including a forecast value of the global solar radiation amount is input, and the forecast value of the corrected global solar radiation amount is output.

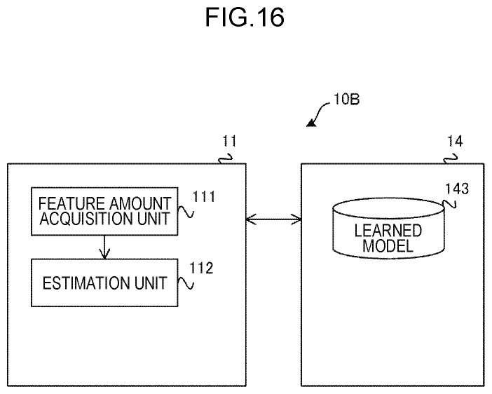

FIG. 16 is a block diagram illustrating an example of a functional configuration of a global solar radiation amount estimation device 10B according to the third embodiment.

As illustrated in FIG. 16, the global solar radiation amount estimation device 10B according to the present embodiment includes a feature amount acquisition unit 111 and an estimation unit 112 as functional configurations. Each functional configuration is achieved by the CPU 11 reading the global solar radiation amount estimation program stored in the ROM 12 or the storage 14, and loading and executing the global solar radiation amount estimation program in the RAM 13.

The storage 14 stores a learned model 143. The learned model 143 is generated by machine learning, as learning data, a set of feature amount data prepared in advance and a corresponding estimation value of the global solar radiation amount or a global solar radiation amount of ground observation. The learned model 143 is a model that is generated by a global solar radiation amount learning device 20A to be described later, receives the feature amount data as an input, and outputs a corrected forecast value of the global solar radiation amount. The learned model 143 is an example of another learned model.

The feature amount acquisition unit 111 acquires feature amount data including a forecast value of the global solar radiation amount. The feature amount data is, for example, data that can be acquired from a weather company or the like. The feature amount data includes, for example, a forecast value of the global solar radiation amount, a forecast value of the temperature, a forecast value of the humidity, a forecast value of the precipitation amount, an integrated solar radiation amount per day calculated from the forecast value of the global solar radiation amount, a temperature difference between the highest temperature and the lowest temperature in one day calculated from the forecast value of the temperature, a humidity difference between the highest humidity and the lowest humidity in one day calculated from the forecast value of the humidity, an integrated precipitation amount per day calculated from the forecast value of the precipitation amount, time information, position information (latitude, longitude), and the like. The feature amount data may include a weather observation value (for example, the global solar radiation amount, the temperature, and the like) closest to the forecast execution date. The feature amount data may include at least a forecast value of the global solar radiation amount, and the data to be included is not particularly limited.

The estimation unit 112 corrects the forecast value of the global solar radiation amount with respect to the feature amount data acquired by the feature amount acquisition unit 111 using the learned model 143. That is, the learned model 143 receives the feature amount data as an input, and outputs the corrected forecast value of the global solar radiation amount.

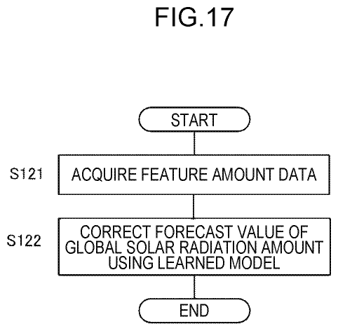

Next, an action of the global solar radiation amount estimation device 10B according to the third embodiment will be described with reference to FIG. 17.

FIG. 17 is a flowchart illustrating an example of a flow of processing by the global solar radiation amount estimation program according to the third embodiment. The processing by the global solar radiation amount estimation program is implemented by writing the global solar radiation amount estimation program stored in the ROM 12 or the storage 14 into the RAM 13 by the CPU 11 of the global solar radiation amount estimation device 10B and executing the global solar radiation amount estimation program.

In step S121 of FIG. 17, the CPU 11 acquires, for example, feature amount data provided from a weather company or the like. As described above, the feature amount data includes, for example, a forecast value of the global solar radiation amount, a forecast value of the temperature, a forecast value of the humidity, a forecast value of the precipitation amount, an integrated solar radiation amount per day calculated from the forecast value of the global solar radiation amount, a temperature difference between the highest temperature and the lowest temperature in a day calculated from the forecast value of the temperature, a humidity difference between the highest humidity and the lowest humidity in a day calculated from the forecast value of the humidity, an integrated precipitation amount per day calculated from the forecast value of the precipitation amount, time information, position information (latitude, longitude), and the like.

In step S122, the CPU 11 receives the feature amount data acquired in step S121 as an input, outputs the corrected forecast value of the global solar radiation amount using the learned model 143, and ends a series of processing by the global solar radiation amount estimation program.

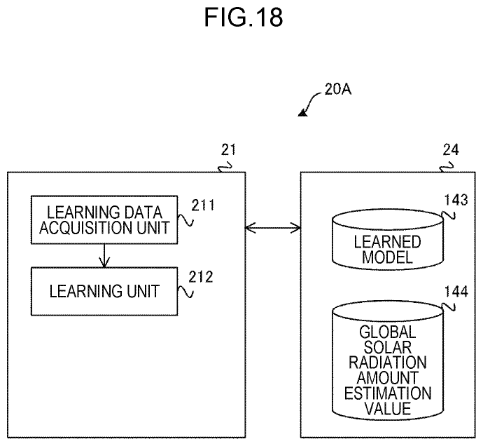

Next, a functional configuration of the global solar radiation amount learning device 20A will be described with reference to FIG. 18.

FIG. 18 is a block diagram illustrating an example of a functional configuration of the global solar radiation amount learning device 20A according to the third embodiment.

As illustrated in FIG. 18, the global solar radiation amount learning device 20A includes a learning data acquisition unit 211 and a learning unit 212 as functional configurations. Each functional configuration is achieved by the CPU 21 reading the global solar radiation amount learning program stored in the ROM 22 or the storage 24, and loading and executing the global solar radiation amount learning program in the RAM 23.

The storage 24 stores a global solar radiation amount estimation value 144. The global solar radiation amount estimation value 144 is an estimation value of the global solar radiation amount obtained by estimation by the estimation unit 102 described in the first embodiment.

The learning data acquisition unit 211 acquires learning data that is a set of feature amount data including a forecast value of a global solar radiation amount and an estimation value of a corresponding global solar radiation amount or a global solar radiation amount of ground observation. The estimation value of the global solar radiation amount is obtained from the global solar radiation amount estimation value 144 stored in the storage 24. The feature amount data is, for example, data that can be acquired from a weather company or the like. As similar to the feature amount data used estimation described above, the feature amount data used in learning is data including, for example, a forecast value of the global solar radiation amount, a forecast value of the temperature, a forecast value of the humidity, a forecast value of the precipitation amount, an integrated solar radiation amount per day calculated from the forecast value of the global solar radiation amount, a temperature difference between the highest temperature and the lowest temperature in a day calculated from the forecast value of the temperature, a humidity difference between the highest humidity and the lowest humidity in a day calculated from the forecast value of the humidity, an integrated precipitation amount per day calculated from the forecast value of the precipitation amount, time information, position information (latitude, longitude), and the like. As similar to the feature amount data used in the above-described estimation, the feature amount data may include a weather observation value (for example, the global solar radiation amount, the temperature, and the like) closest to the forecast execution date. That is, the learning data is data in which the feature amount data is used as an explanatory variable and the estimation value of the global solar radiation amount or the global solar radiation amount of the ground observation is used as an objective variable. As a result, influences of terrain, clouds, and the like are considered.

The learning unit 212 performs machine learning using the learning data acquired by the learning data acquisition unit 211 to generate the learned model 143 that receives the power feature amount data as an input and outputs the corrected forecast value of the global solar radiation amount. Here, a general hyperparameter search algorithm is used as the learning model used for machine learning, and for example, a neural network or the like is applied. The learned model 143 generated by the learning unit 212 is stored in the storage 24 and also stored in the storage 14 of the global solar radiation amount estimation device 10B.

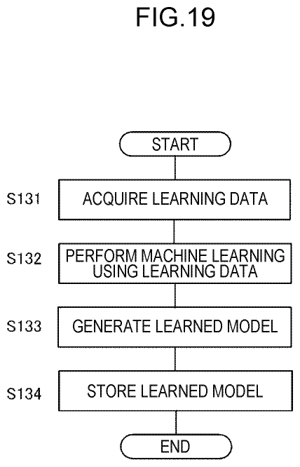

Next, an action of the global solar radiation amount learning device 20A according to the third embodiment will be described with reference to FIG. 19.

FIG. 19 is a flowchart illustrating an example of a flow of processing by the global solar radiation amount learning program according to the third embodiment. The processing by the global solar radiation amount learning program is implemented by writing the global solar radiation amount learning program stored in the ROM 22 or the storage 24 into the RAM 23 by the CPU 21 of the global solar radiation amount learning device 20A and executing the global solar radiation amount learning program.

In step S131 of FIG. 19, the CPU 21 acquires learning data that is a set of feature amount data including a forecast value of a global solar radiation amount and an estimation value of a corresponding global solar radiation amount or a global solar radiation amount of ground observation. As similar to the feature amount data used estimation described above, the feature amount data used in learning is data including, for example, a forecast value of the global solar radiation amount, a forecast value of the temperature, a forecast value of the humidity, a forecast value of the precipitation amount, an integrated solar radiation amount per day calculated from the forecast value of the global solar radiation amount, a temperature difference between the highest temperature and the lowest temperature in a day calculated from the forecast value of the temperature, a humidity difference between the highest humidity and the lowest humidity in a day calculated from the forecast value of the humidity, an integrated precipitation amount per day calculated from the forecast value of the precipitation amount, time information, position information (latitude, longitude), and the like.

In step S132, the CPU 21 performs machine learning by a general hyperparameter search algorithm using the learning data acquired in step S131.

In step S133, the CPU 21 performs machine learning in step S132 to generate the learned model 143 that receives the feature amount data as an input and outputs the corrected forecast value of the global solar radiation amount.

In step S134, the CPU 21 stores the learned model 143 generated in step S133 in, for example, the storage 14 of the global solar radiation amount estimation device 10B, and ends a series of processes by the global solar radiation amount learning program.

As described above, according to the present embodiment, the learned model is generated by performing machine learning using the learning data in which the feature amount data including the forecast value of the global solar radiation amount is used as the explanatory variable and the estimation value of the global solar radiation amount or the global solar radiation amount of the ground observation is used as the objective variable. By inputting the feature amount data including the forecast value of the global solar radiation amount to the learned model, it is possible to output a corrected and more accurate forecast value of the global solar radiation amount.

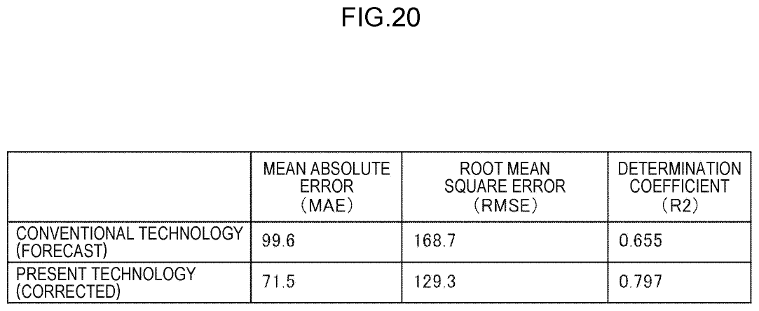

Next, an example of an experimental result according to the present embodiment will be described with reference to FIGS. 20 to 26.

FIG. 20 is a diagram illustrating a comparison example between a corrected forecast value of a global solar radiation amount according to the present technology and a forecast value of a global solar radiation amount according to a conventional technology. The learning period was set to Jan. 1, 2020 to Dec. 31, 2020, and the evaluation period was set to Jan. 1, 2021 to Dec. 31, 2021. As evaluation indexes, a mean absolute error (MAE), a root mean square error (RMSE), and a determination coefficient (R2) were used. The conventional technology is a technology of acquiring a forecast value using a meteorological satellite image.

As illustrated in FIG. 20, it can be seen that in any of the above evaluation indexes, the corrected forecast value of the global solar radiation amount according to the present technology (present technology (correction)) has higher accuracy than the forecast value of the global solar radiation amount according to the conventional technology (conventional method (forecast)).

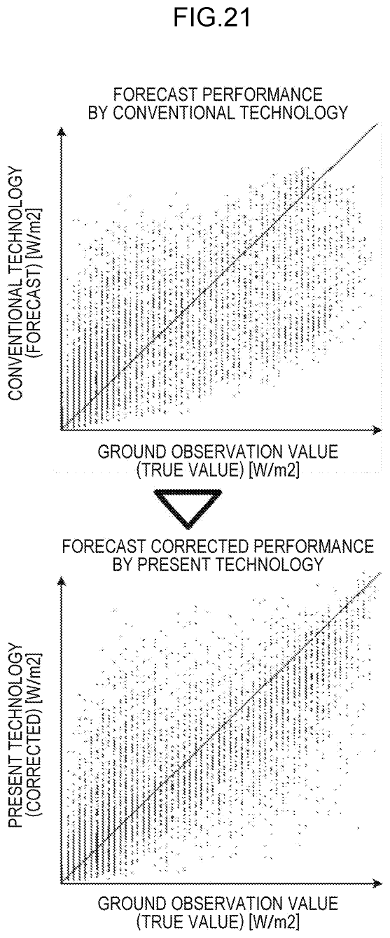

FIG. 21 is a scatter diagram illustrating a comparative example of correction performance of a forecast according to the present technology and performance of a forecast according to the conventional technology. In the scatter diagram (upper diagram) according to the conventional technology, the horizontal axis represents the ground observation value (true value), and the vertical axis represents the forecast value by the conventional method (forecast). In the scatter diagram (lower diagram) according to the present technology, the horizontal axis represents the ground observation value (true value), and the vertical axis represents the forecast value by the present technology (correction).

According to the scatter diagram according to the present technology, it can be seen that the forecast value of the corrected global solar radiation amount is accurately obtained with respect to the ground observation value (true value) as compared with the scatter diagram according to the conventional technology.

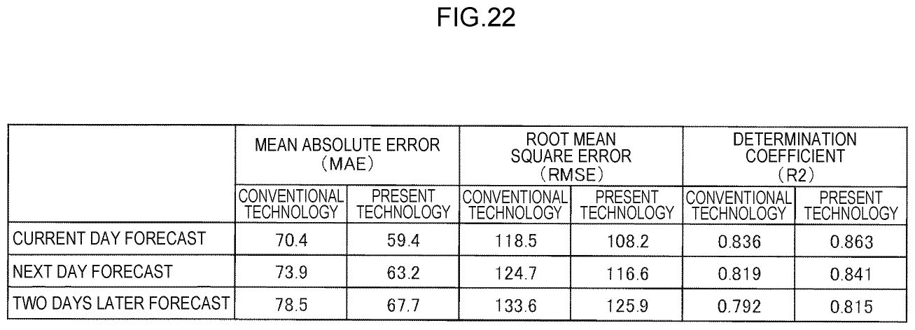

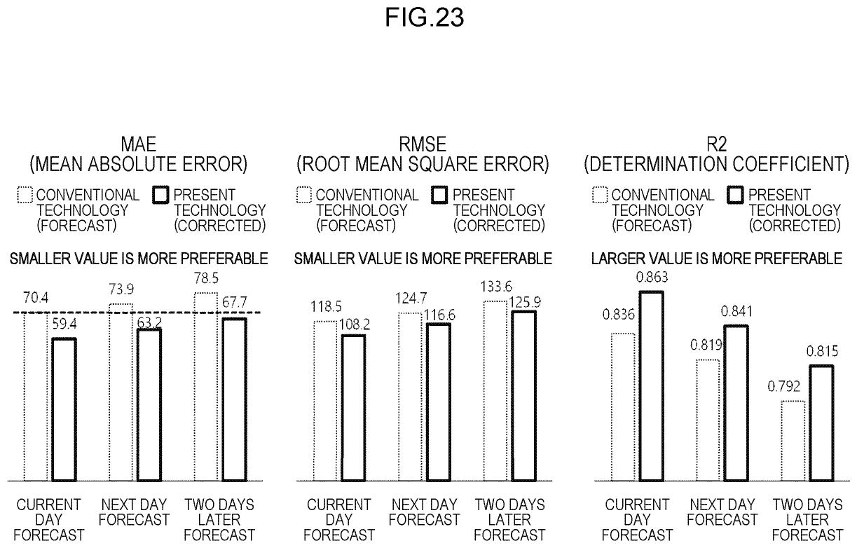

FIG. 22 is a diagram illustrating a comparison example between a corrected forecast value of a global solar radiation amount according to the present technology and a forecast value of a global solar radiation amount according to a conventional technology. The graph of FIG. 23 is a graph of the numerical values of FIG. 22.

In FIGS. 22 and 23, the evaluation period was set to May 2021. As evaluation indexes, a mean absolute error (MAE), a root mean square error (RMSE), and a determination coefficient (R2) were used. It can be seen that, due to the correction of the forecast value of the global solar radiation amount according to the present technology, the error is reduced on the current day, the next day, and the two days later (the last 72 hours) as compared with the conventional technology. In addition, the corrected forecast value of the two days later has a smaller error than the conventional current day forecast (for example, MAE is 70.4->67.7), and the error is reduced as a whole.

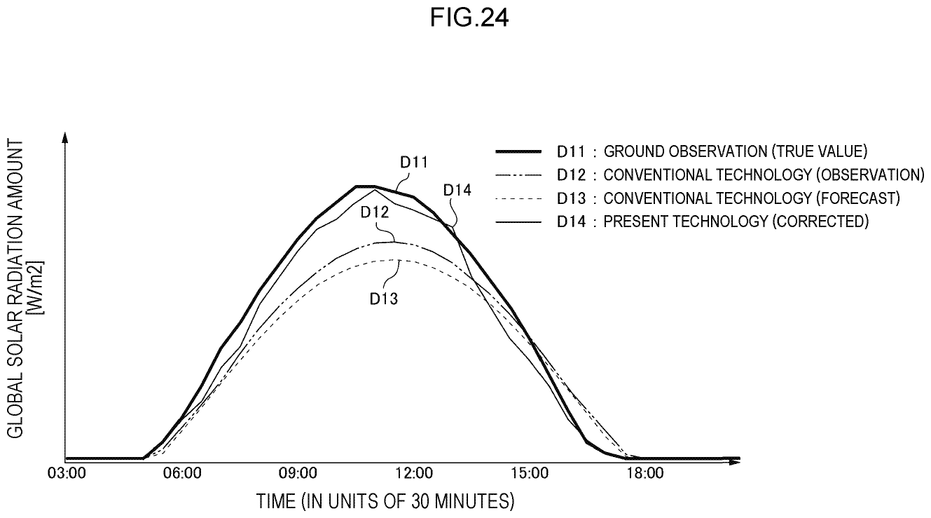

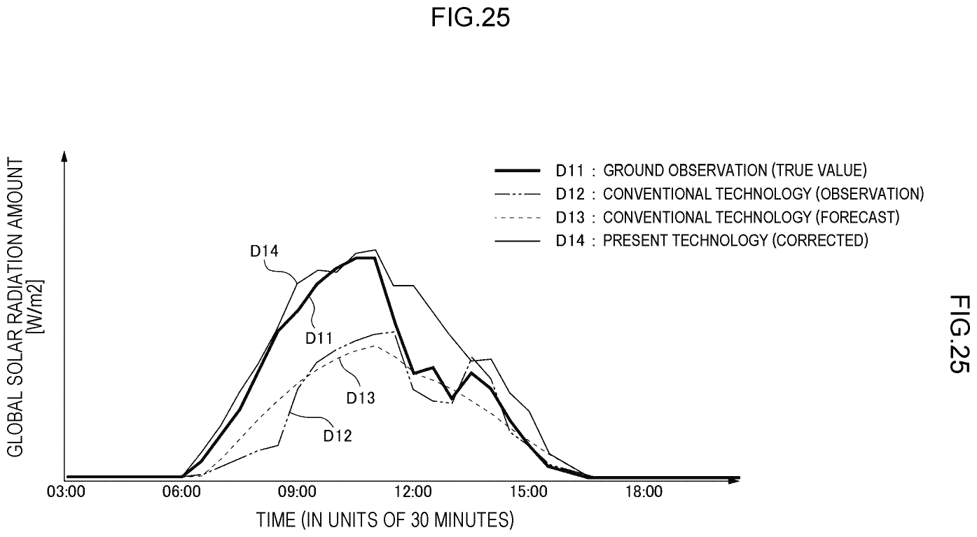

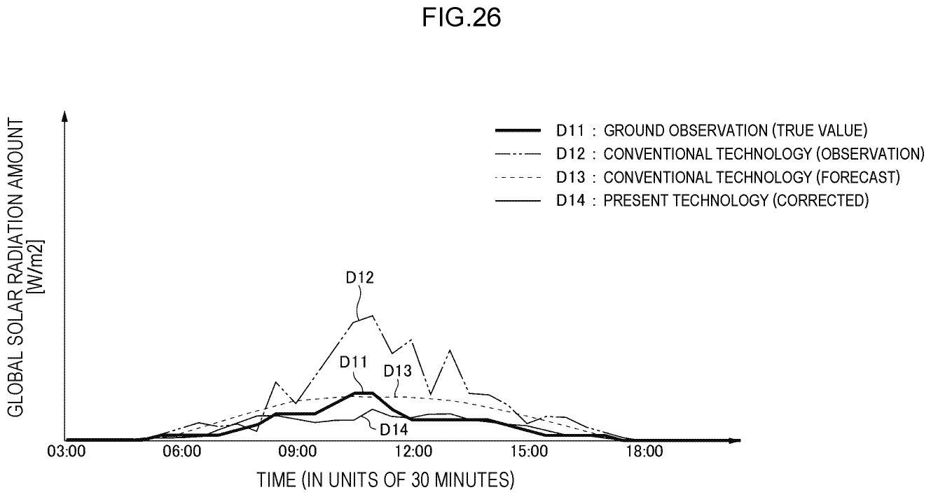

FIG. 24 is a graph illustrating a comparative example of a global solar radiation amount on a fine day. FIG. 25 is a graph illustrating a comparative example of a global solar radiation amount on a cloudy day. FIG. 26 is a graph illustrating a comparative example of a global solar radiation amount on a cloudy day. In FIGS. 24 to 26, the vertical axis represents the global solar radiation amount (unit: W/m²), and the horizontal axis represents the time zone. D11 represents a global solar radiation amount (correct data: true value) of ground observation, D12 represents an observation value of a global solar radiation amount obtained by analysis of a meteorological satellite image (conventional method), D13 represents a forecast value of a global solar radiation amount obtained from a meteorological satellite image (conventional method), and D14 represents a forecast value of a global solar radiation amount corrected using feature amount data (method of the present technology). However, the examples of FIGS. 24 to 26 illustrate data observed in a certain photovoltaic power generation facility.

As illustrated in FIGS. 24 to 26, it can be seen that the forecast value D14 of the global solar radiation amount corrected using the feature amount data is closer to the global solar radiation amount D11 which is correct data than the observation value D12 and the forecast value D13 of the global solar radiation amount obtained using the meteorological satellite image regardless of the weather. That is, it can be seen that the forecast value D14 of the global solar radiation amount corrected using the feature amount data has higher accuracy than the observation value D12 and the forecast value D13 of the global solar radiation amount obtained using the meteorological satellite image.

The global solar radiation amount estimation processing or the global solar radiation amount learning processing executed by the CPU by reading the program in the above embodiment may be executed by various processors other than the CPU. Examples of the processors in this case include a programmable logic device (PLD), a circuit configuration of which can be changed after manufacturing, such as a field-programmable gate array (FPGA), and a dedicated electric circuit that is a processor having a circuit configuration exclusively designed for executing a specific process, such as an application specific integrated circuit (ASIC). Alternatively, the global solar radiation amount estimation processing or the global solar radiation amount learning processing may be executed by one of those various processors or may be executed by a combination of two or more processors of the same type or different types (for example, a plurality of FPGAs, and a combination of a CPU and an FPGA). More specifically, a hardware structure of the various processors is an electric circuit in which circuit elements such as semiconductor elements are combined.

Furthermore, in the above embodiment, a mode in which the global solar radiation amount estimation program or the global solar radiation amount learning program is stored (also referred to as “installed”) in the ROM or the storage in advance has been described. However, the present disclosure is not limited to this. The global solar radiation amount estimation program or the global solar radiation amount learning program may be provided in the form stored in a non-transitory storage medium such as a compact disk read only memory (CD-ROM), a digital versatile disk read only memory (DVD-ROM), or a universal serial bus (USB) memory. Furthermore, the global solar radiation amount estimation program or the global solar radiation amount learning program may be downloaded from an external device via a network.

All documents, patent applications, and technical standards described in this specification are incorporated herein by reference to the same extent as in a case where a case where incorporation by reference of each document, patent application, and technical standard is specifically and individually described.

Regarding the above embodiments, the following supplementary notes are further disclosed.

### (Supplement 1)

A global solar radiation amount estimation device including:
a memory; and
at least one processor connected to the memory,
the processor is configured to
acquire power generation actual data including a power generation amount at a power generation point, and
estimate a global solar radiation amount corresponding to the power generation actual data acquired, using a learned model that is generated by machine learning, as learning data, a set of the power generation actual data prepared in advance and a corresponding global solar radiation amount of ground observation, receives the power generation actual data as an input, and outputs the global solar radiation amount.

### (Supplement 2)

A non-transitory storage medium storing a program that can be executed by a computer to execute a global solar radiation amount estimation processing,
the global solar radiation amount estimation processing including
acquiring power generation actual data including a power generation amount at a power generation point, and
estimating a global solar radiation amount corresponding to the power generation actual data acquired, using a learned model that is generated by machine learning, as learning data, a set of the power generation actual data prepared in advance and a corresponding global solar radiation amount of ground observation, receives the power generation actual data as an input, and outputs the global solar radiation amount.

### REFERENCE SIGNS LIST

10, 10A, 10B Global solar radiation amount estimation device
11, 21 CPU
12, 22 ROM
13, 23 RAM
14, 24 Storage
15, 25 Input unit
16, 26 Display unit
17, 27 Communication I/F
18, 28 Bus
20, 20A Global solar radiation amount learning device
101, 111 Feature amount acquisition unit
102, 112 Estimation unit
103 Global solar radiation amount acquisition unit
104 Representative value calculation unit
141, 143 Learned model
142 Estimation result
144 Global solar radiation amount estimation value
201, 211 Learning data acquisition unit
202, 212 Learning unit

1. A global solar radiation amount estimation device comprising:
a memory; and
at least one processor coupled to the memory, the at least one processor being configured to:
acquire power generation actual data including a power generation amount at a power generation point; and
estimate a global solar radiation amount corresponding to the acquired power generation actual data using a learned model that is generated by machine learning, as learning data, a set of power generation actual data prepared in advance and a corresponding global solar radiation amount of ground observation, that receives the power generation actual data as an input, and that outputs the global solar radiation amount.

2. The global solar radiation amount estimation device according to claim 1,
wherein the acquired power generation actual data includes latest power generation actual data, and
wherein the at least one processor estimates a global solar radiation amount corresponding to the latest power generation actual data.

3. The global solar radiation amount estimation device according to claim 1,
wherein the acquired power generation actual data includes at least one of temperature information, humidity information, time information, equipment information, or installation location information at the power generation point.

4. The global solar radiation amount estimation device according to claim 1, wherein the at least one processor is configured to:
acquire estimation results of global solar radiation amounts at all power generation points existing in a predetermined mesh; and
calculate a representative value of a global solar radiation amount of the mesh from the acquired estimation results of the global solar radiation amounts.

5. The global solar radiation amount estimation device according to claim 4,
wherein the representative value of the global solar radiation amount of the mesh is expressed as a median value or a weighted average of the global solar radiation amounts at all power generation points existing in the mesh.

6. The global solar radiation amount estimation device according to claim 1,
wherein the at least one processor:
acquires feature amount data including a forecast value of the global solar radiation amount, and
corrects the forecast value of the global solar radiation amount with respect to the acquired feature amount data by using another learned model that is generated by machine learning, as learning data, a set of feature amount data prepared in advance and a corresponding estimation value of the global solar radiation amount or a global solar radiation amount of ground observation, and that is configured to receive the feature amount data as an input and output a corrected forecast value of the global solar radiation amount.

7. A global solar radiation amount learning device comprising:
a memory; and
at least one processor coupled to the memory, the at least one processor being configured to:
acquire learning data that is a set of power generation actual data including a power generation amount at a power generation point and a corresponding global solar radiation amount of ground observation; and
generate a learned model that receives the power generation actual data as an input and outputs the global solar radiation amount, by performing machine learning using the acquired learning data.

8. The global solar radiation amount learning device according to claim 7,
wherein the at least one processor:
acquires other learning data that is a set of feature amount data including a forecast value of a global solar radiation amount and an estimation value of a corresponding global solar radiation amount or a global solar radiation amount of ground observation, and
performs machine learning using the acquired other learning data to generate another learned model that receives feature amount data as an input and outputs a corrected forecast value of the global solar radiation amount.

9. A global solar radiation amount estimation method comprising:
acquiring power generation actual data including a power generation amount at a power generation point; and
estimating a global solar radiation amount corresponding to the acquired power generation actual data, using a learned model that is generated by machine learning, as learning data, a set of power generation actual data prepared in advance and a corresponding global solar radiation amount of ground observation, that receives the power generation actual data as an input, and that outputs the global solar radiation amount.

10. A non-transitory storage medium storing a global solar radiation amount estimation program for causing a computer to function as the global solar radiation amount estimation device according to claim 1.
